(19) United States
(12) Patent Application Publication
(10) Pub. No.: US 2022/0135049 A1
(43) Pub. Date: May 5, 2022

(54) DISPLAY CONTROL APPARATUS, DISPLAY CONTROL METHOD, AND STORAGE MEDIUM

(71) Applicant: CANON KABUSHIKI KAISHA, Tokyo (JP)

(72) Inventor: Shinya Taoki, Kanagawa (JP)

(21) Appl. No.: 17/507,642

(22) Filed: Oct. 21, 2021

(30) Foreign Application Priority Data
Oct. 29, 2020 (JP) 2020-181728

(51) Int. Cl. B60W 40/08

(52) U.S. Cl. CPC B60W 40/08; B60W 2420/42; B60W 2540/01; B60W 2300/10; B60W 2422/95; B60W 2520/04

(57) ABSTRACT

A display control apparatus which controls a display of a plurality of captured images captured by one or a plurality of image capturing apparatuses installed inside of a movable body includes a determination unit configured to determine whether movement of the movable body is stopped, and a display control unit configured to control the display of the plurality of captured images on a display unit so that a first captured image having an angle of view for capturing a side of the movable body from the inside of the movable body and a second captured image different from the first captured image are selectively displayed among the plurality of captured images based on at least a result of the determination by the determination unit.

### BACKGROUND

### Field of the Disclosure

The present disclosure relates to a display control technique.

### Description of the Related Art

Image capturing apparatuses are used for safety of buses and trains. Japanese Patent Application Laid-Open No. 2002-104189 discusses a method in which a driver checks the state of a platform while at a driver's seat. Specifically, according to Japanese Patent Application Laid-Open No. 2002-104189, an image capturing apparatus installed at the platform captures a video near the boundary of the platform and a train. The video captured by the image capturing apparatus is then wirelessly transmitted to the train while the train stops at the platform.

### SUMMARY

The present disclosure is directed to the provision of a technique for appropriately displaying an image captured by an image capturing apparatus which is installed in a movable body.

According to an aspect of the present disclosure, a display control apparatus which controls a display of a plurality of captured images captured by one or a plurality of image capturing apparatuses installed inside of a movable body includes a determination unit configured to determine whether movement of the movable body is stopped, and a display control unit configured to control the display of the plurality of captured images on a display unit so that a first captured image having an angle of view for capturing a side of the movable body from the inside of the movable body and a second captured image different from the first captured image are selectively displayed among the plurality of captured images based on at least a result of the determination by the determination unit.

According to another aspect of the present disclosure, a display control apparatus which controls a display of a plurality of captured images captured by one or a plurality of image capturing apparatuses installed inside of a movable body includes a determination unit configured to determine whether movement of the movable body is stopped, and a display control unit configured to control the display of the plurality of captured images on a display unit so that one of a first captured image having an angle of view for capturing a side of the movable body from the inside of the movable body and a second captured image different from the first captured image is displayed in a larger size than the other among the plurality of captured images based on at least a result of the determination by the determination unit.

Further features of the present disclosure will become apparent from the following description of exemplary embodiments with reference to the attached drawings.

### BRIEF DESCRIPTION OF THE DRAWINGS

FIG. 1A illustrates a system configuration according to one or more aspects of the present disclosure.

FIG. 1B illustrates a system configuration according to one or more aspects of the present disclosure.

FIG. 2 is a functional block diagram according to one or more aspects of the present disclosure.

FIG. 3A illustrates a view of the inside of a bus according to one or more aspects of the present disclosure.

FIG. 3B illustrates the bus according to one or more aspects of the present disclosure.

FIG. 4 illustrates a relationship between a fisheye image and a panoramic display according to one or more aspects of the present disclosure.

FIG. 5A is a flowchart according to one or more aspects of the present disclosure.

FIG. 5B is a flowchart according to one or more aspects of the present disclosure.

FIG. 6 is a flowchart illustrating a subroutine of stop position confirmation processing according to one or more aspects of the present disclosure.

FIG. 7 illustrates a division example in a case where a fisheye image is expanded into a panoramic image according to one or more aspects of the present disclosure.

FIG. 8 is a flowchart illustrating a subroutine of image priority confirmation processing according to one or more aspects of the present disclosure.

FIG. 9 illustrates display examples of dewarped images in a client apparatus according to one or more aspects of the present disclosure.

FIG. 10 illustrates a display example of a double panorama image according to one or more aspects of the present disclosure.

FIG. 11A is a flowchart according to one or more aspects of the present disclosure.

FIG. 11B is a flowchart according to one or more aspects of the present disclosure.

FIG. 12 illustrates an example of a fisheye image according to one or more aspects of the present disclosure.

FIG. 13A illustrates a display example of a captured image.

FIG. 13B illustrates a display example of a captured image.

FIG. 13C illustrates a display example of a captured image.

FIG. 13D illustrates a display example of a captured image.

FIG. 14 is a block diagram illustrating an example of a hardware configuration of an image capturing apparatus and a client apparatus according to one or more aspects of the present disclosure.

### DESCRIPTION OF THE EMBODIMENTS

Various exemplary embodiments of the present disclosure will be described in detail below with reference to the attached drawings. Configurations described according to the following exemplary embodiments are examples, and the present disclosure is not limited to the configurations described according to the following exemplary embodiments. In the following descriptions, a bus is described as an example of a movable body in which an image capturing apparatus is installed, but the present disclosure can be applied to other movable bodies such as a train and an ordinary passenger vehicle. In any case, an image capturing apparatus is installed inside the movable body and at least captures an image of the inside of the movable body.

According to each exemplary embodiment, an image to be captured by an image capturing apparatus may be a moving image or a still image.

Further, according to each exemplary embodiment, a monitoring camera is described as an example, but the present disclosure can be applied to a camera other than a camera used for monitoring. For example, the present disclosure can also be applied to an image capturing apparatus or a display-control apparatus that captures not a video for surveillance purposes but a video for broadcasting purposes, a movie film, and a video for personal purposes, and a display control apparatus.

Further, according to the following exemplary embodiments, an image capturing apparatus that can capture an image referred to as an omni-directional image using an omni-directional mirror and a fisheye lens is described as an example, Such an image capturing apparatus can capture an image of its periphery in a wide range and can capture an annular or circular image (also referred to as a fisheye image) of approximately 180 degrees by a single image capturing unit. However, an omni-directional image is an example, and the present disclosure can be applied to a standard monitoring camera that does not use a fisheye lens as described below. A term “omni-direction” is not necessarily limited to a case of capturing an image of an entire space in which the image capturing apparatus is installed. The terms “omni-directional image”, “omni-directional camera”, and “fisheye image” are commonly used terms, so that these terms are used as appropriate in each exemplary embodiment as well.

According to each exemplary embodiment, an “omni-directional camera” may be an image capturing apparatus that captures an image using an omni-directional mirror and a fisheye lens. “omni-directional image (fisheye image)” may be an image that is captured by the image capturing apparatus.

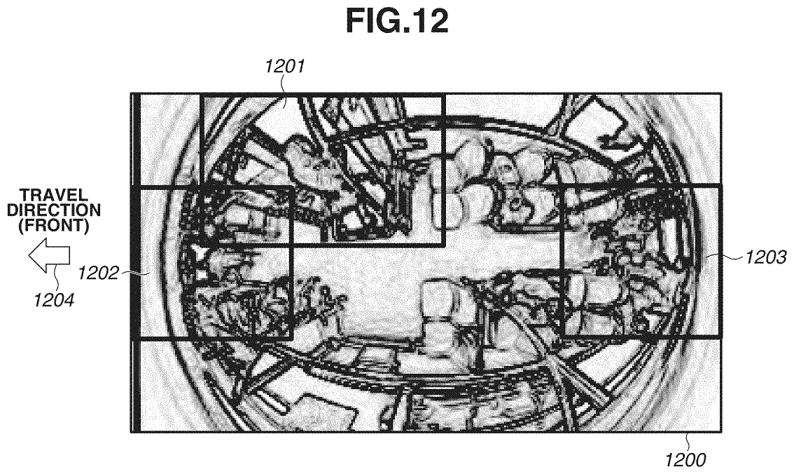

First, outlines of a first exemplary embodiment are described with reference to FIG. 12. FIG. 12 illustrates an example of a fisheye image 1200 showing the inside of a bus that is captured by an image capturing apparatus using a fisheye lens. A travel direction (a front direction) 1204 of the bus is also indicated in FIG. 12. In a case where a panoramic image obtained by dewarping a fisheye image is used for monitoring the inside of the bus, a priority area to be monitored is different depending on the operating situation of the bus. It is thus difficult for a user to manually change the position at which a panoramic image is to be generated according to the operating situation of the bus.

For example, in a case where the bus stops at a bus stop, it is desirable to display a captured image (a first captured image) having an angle of view for capturing a side of the bus from the inside of the bus and including a doorway (a door) of the bus as an area 1201 illustrated in FIG. 12 in order to monitor passengers getting on and off the bus. On the other hand, in a case where the bus is traveling, it is desirable to display a captured image (a second captured image) obtained by capturing the rear or the front of the bus from the inside of the bus in order to monitor passenger seats. Particularly, it is desirable that the captured image has an angle of view for capturing the rear of the bus from at least a position near the center of the bus or the front side of the center of the bus. For example, the captured image is an image in which the rear of the bus is mainly captured as illustrated in an area 1203 in FIG. 12. Further, in a case where the bus is traveling, it may be desirable in some cases to display a captured image obtained by capturing the front of the bus from near the center of the bus or the rear side of the center of the bus in order to monitor the passenger seats. For example, it is a case of checking an image in which the front of the bus is mainly captured as illustrated in an area 1202 in FIG. 12.

The above-described captured images may be captured by an image capturing apparatus using a fisheye lens or a standard image capturing apparatus not using a fisheye lens. In a case where the fisheye lens is not used, however, it is often better to use a plurality of image capturing apparatuses. In the following description of the first exemplary embodiment, two examples, an example of the image capturing apparatus using the fisheye lens and an example of the image capturing apparatus not using the fisheye lens, are described.

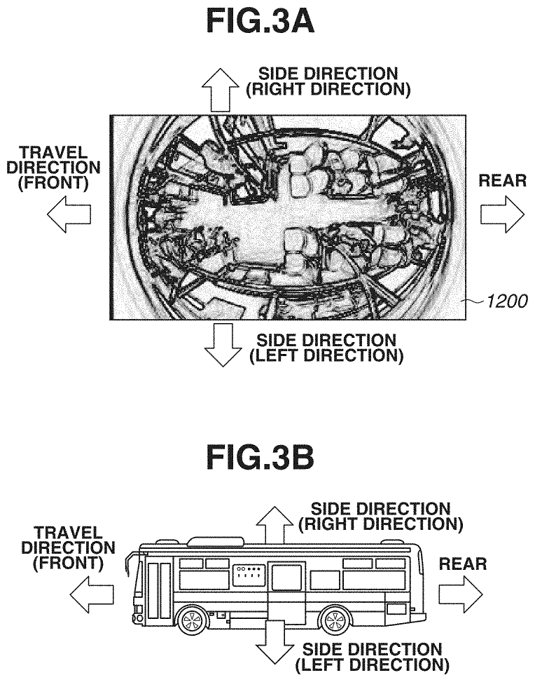

The travel direction (the front direction), the rear direction, and the side directions of the bus are as indicated in FIGS. 3A and 3B. FIG. 3A is a view of the inside of the bus viewed from directly above. FIG. 3B is a view of the bus viewed from the side direction.

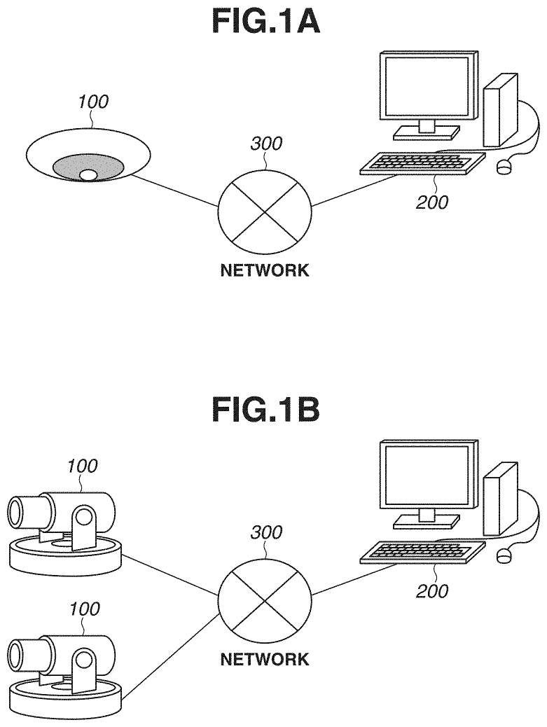

First, a system configuration according to the present exemplary embodiment is described with reference to FIGS. 1A and 1B.

In FIG. 1A, an image capturing apparatus (a network camera) 100 is an image capturing apparatus that captures an image using a fisheye lens, so that the image capturing apparatus 100 can capture a substantially circular fisheye image of 180 degrees. According to the present exemplary embodiment, the image capturing apparatus 100 is installed on a ceiling portion inside a bus or a train with the image capturing direction directed downward or obliquely downward. FIG. 1A illustrates an example in which a single omni-directional camera is used, but a plurality of omni-directional cameras may be used. In a case where a single omni-directional camera is used, it is desirable to install the camera near the center of the vehicle.

An image captured by the image capturing apparatus using the fisheye lens is circular. However, a panoramic image may be generated in some cases by cutting out a part of the fisheye image and performing distortion correction on the partial image in order to make the image easily visible for a user. In this case, the image capturing apparatus has a function of dividing the fisheye image by an arbitrary line segment in a circumferential direction of the fisheye image and then performing distortion correction processing (dewarping) on the divided image so that the circumferential direction of the fisheye image is aligned with a perpendicular direction of a corrected image, thereby generating an image in which an object is erected (hereinbelow, referred to as a panoramic image as appropriate). The image capturing apparatus also has a double panorama function of displaying panoramic images in two areas.

Next, FIG. 1B illustrates an example of a system configuration including image capturing apparatuses (network cameras) 100 not using the fisheye lens. In this example, two image capturing apparatuses 100 are used, but three or more image capturing apparatuses 100 may be used. In a case where two image capturing apparatuses 100 are used, one of the image capturing apparatuses 100 captures an image having the angle of view for capturing the side of the bus from the inside of the bus and including the doorway (the door) of the bus as the area 1201 illustrated in FIG. 12. The other one captures an image having the angle of view for capturing the rear of the bus from at least the position near the center or the front side of the center of the bus. Another image capturing apparatus 100 may be further installed to capture an image having an angle of view for capturing the front of the bus from near the center of the bus or the rear side of the center of the bus.

In FIGS. 1A and 1B, the image capturing apparatus 100 or the image capturing apparatuses 100 and a client apparatus (a display control apparatus) 200 are communicably connected to each other via a network 300.

The client apparatus 200 transmits a command for specifying an image quality of an image to be captured by the image capturing apparatus 100, a position of an area from which an image is cut out, or the like to the image capturing apparatus 100. The image capturing apparatus 100 executes an operation according to the command and transmits a response to the command to the client apparatus 200. Such communication between the image capturing apparatus or apparatuses 100 and the client apparatus 200 can be executed in compliance with, for example, the Open Network Video Interface Forum (ONVIF) specification, but various communication methods can be used without being limited to the above one. A communication method using a wired cable and a wireless communication method may be used

According to each exemplary embodiment, an example is described in which the client apparatus 200 executes a function as a display control apparatus, but the image capturing apparatus 100 may execute a part or whole of the function as the display control apparatus, In other words, the image capturing apparatus 100 and the client apparatus 200 may execute the function as the display control apparatus in collaboration with each other.

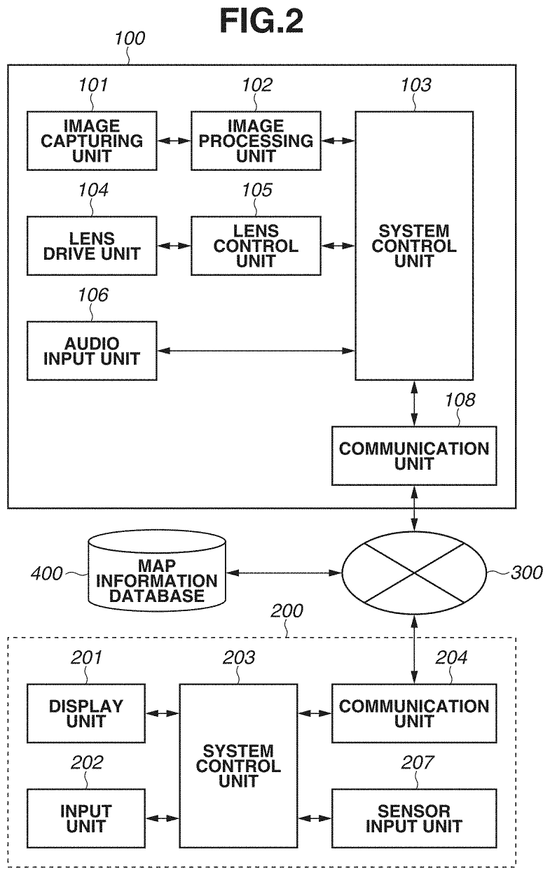

FIG. 2 is a functional block diagram and a system configuration diagram of the image capturing apparatus 100, the client apparatus 200, and a map information database 400 according to the first exemplary embodiment of the present disclosure. A configuration and a function of each unit in the image capturing apparatus 100 are described with reference to FIG. 2.

The image capturing apparatus 100 includes an image capturing unit 101, an image processing unit 102, a system control unit 103, a lens drive unit 104, a lens control unit 105, an audio input unit 106, and a communication unit 108.

The image capturing unit 101 receives light which forms an image through a lens by an image capturing element and generates an image capturing signal by converting the received light into an electric charge. As the image capturing element, for example, a complementary metal oxide semiconductor (CMOS) image sensor can be used. A charge coupled device (CCD) image sensor may also be used as the image capturing element.

The image processing unit 102 generates image data by digitizing the image capturing signal converted by the image capturing unit 101. At this time, the image processing unit 102 also performs various types of image processing for correcting the image quality.

The image processing unit 102 may further perform compression coding on the image data and generate compression coded image data.

The communication unit 108 transmits the image data generated by the image processing unit 102 to the client apparatus 200. The image data described here is, for example, image data of a moving image. The communication unit 108 receives a command transmitted by the client apparatus 200 and transfers the command to the system control unit 103. The communication unit 108 transmits a response to the command to the client apparatus 200 according to control by the system control unit 103. The system control unit 103 also functions as a communication control unit.

The system control unit 103 of the image capturing apparatus 100 analyzes the command received by the communication unit 108 and performs processing according to the command.

For example, the system control unit 103 causes the image processing unit 102 to adjust the image quality according to the command. The system control unit 103 instructs the image processing unit 102 to adjust the image quality and the lens control unit 105 to control zoom and focus.

The lens control unit 105 controls the lens drive unit 104 based on the transmitted instruction.

The lens drive unit 104 includes a drive system for a focus lens and a zoom lens and a motor as a driving source of the drive system, and an operation of the lens drive unit 101 is controlled by the lens control unit 105.

The audio input unit 106 collects audio data through an audio input device such as a microphone. Examples of the audio input device include a microelectromechanical system (MEMS) microphone, a condenser microphone, and an audio codec device. The audio input device 16 may be built in the camera or may be an external device provided outside the camera,

Next, a configuration and a function of each unit in the client apparatus 200 are described with reference to FIG. 2.

The client apparatus 200 can be realized by a computer such as a personal computer. The client apparatus 200 may be also realized by installing specific software on an onboard device such as a navigation device. Furthermore, the client apparatus 200 may be realized by installing specific software on a smartphone and a tablet terminal.

A display unit 201 displays an image based on the image data received from the image capturing apparatus 100. The display unit 201 also displays a graphical user interface (hereinbelow, referred to as a GUI) for controlling the camera. The above-described display is performed according to control by a system control unit 203. In other words, the system control unit 203 also has a function as a display control unit. The display unit 201 can be realized by a display device including a liquid crystal panel and an organic electroluminescent (EL) panel. The display unit 201 is installed at a position, for example, where a bus driver can see.

In a case where the image capturing apparatus 100 and the client apparatus 200 are connected to each other by the wireless communication method, the client apparatus 200 may be installed at a monitoring center outside the vehicle.

An input unit 202 can be realized by a device such as a keyboard and a mouse, and a user of the client apparatus 200 performs an operation on the GUI using the input unit 202. The input unit 202 may be realized by using a touch panel.

The system control unit 203 of the client apparatus 200 generates a command in response to a user operation and causes a communication unit 204 to transmit the command to the image capturing apparatus 100. Furthermore, the system control unit 203 causes the display unit 201 to display the image data received from the image capturing apparatus 100 via the communication unit 204. As described above, the system control unit 203 also functions as a communication control unit and a display control unit.

A sensor input unit 207 acquires input from an encoder for an acceleration sensor or a position detecting sensor, and a sensor device such as a Global Positioning System (GPS). A position information acquisition unit such as the GPS may be installed in the client apparatus 200. Position information about the bus may be acquired from a navigation device included in the bus. The sensor input unit 207 may acquire information about a bus brake operation and control information about a bus speed and the like from various electronic devices controlling the bus, in addition to the above-described information.

As described above, the client apparatus 200 can acquire the image data from the image capturing apparatus 100 via the network 300 and display the image data. The client apparatus 200 can control the image capturing apparatus 100 by transmitting a command thereto via the network 300.

The map information database 400 is accessed by the image capturing apparatus 100 and the client apparatus 200 via the network 300 and provides map information to the image capturing apparatus 100 and the client apparatus 200. The map information database 400 may be provided in the client apparatus 200.

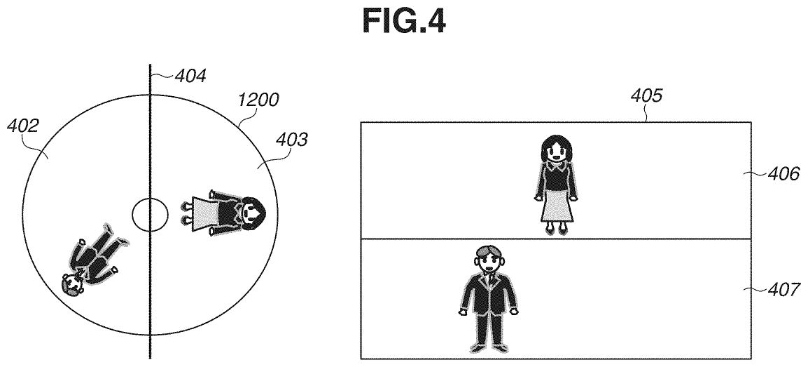

FIG. 4 illustrates a relationship between a fisheye image and a panoramic display according to the configuration example in FIG. 1A. FIG. 4 illustrates the fisheye image 1200 and a dividing line 404 drawn on the fisheye image for expanding the fisheye image into panoramic images. Areas 402 and 403 divided by the dividing line 404 are panoramic expansion areas. An image 405 is a display example of a double panorama image obtained by dividing the fisheye image into two parts and expanding the two parts into panoramic images. A panoramic image 406 is generated by dewarping (i.e., performing distortion correction on) the area 403. A panoramic image 407 is generated by dewarping the area 402.

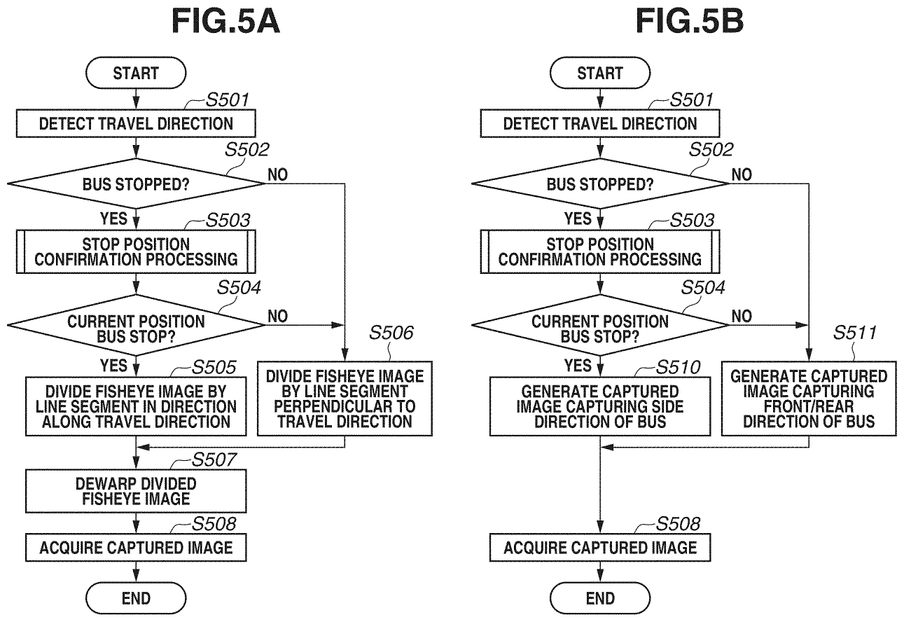

Next, a flow of an image acquisition method according to the present exemplary embodiment of the present disclosure is described with reference to FIGS. 5A and 5B. A part or all of the operations performed by the system control unit 203 of the client apparatus 200 in the following description can be executed by the system control unit 103 of the image capturing apparatus 100.

FIGS. 5A and 5B are different from each other only in steps S507, S510, and S511, and the other steps are the same. FIG. 5A illustrates an example in a case where the image capturing apparatus 100 using the fisheye lens is used. FIG. 5B illustrates an example in a case where a plurality of image capturing apparatuses 100 not using the fisheye lens is used.

First, the example in FIG. 5A is described. In step S501, the system control unit 203 detects the travel direction of the bus in which the image capturing apparatus 100 is installed, based on information obtained from the sensor input unit 207. Since the bus basically goes forward, the processing in step S501 can be omitted.

in step S502, the system control unit 203 determines whether the bus in which the image capturing apparatus 100 is installed is stopped (the movement is stopped), based on the information obtained from the sensor input unit 207. In a case where a speed of the bus is a predetermined speed (for example, the speed of 5 km per hour) or less, it may be determined that the bus is stopped. In a case where the bus is stopped (YES in step S502), the processing proceeds to step S503. In a case where the bus is not stopped (NO in step S502), the processing proceeds to step S506. As described above, the system control unit 203 also functions as a determination unit for determining whether the bus is stopped.

In step S503, the system control unit 203 performs stop position confirmation processing in order to confirm where the bus is stopped.

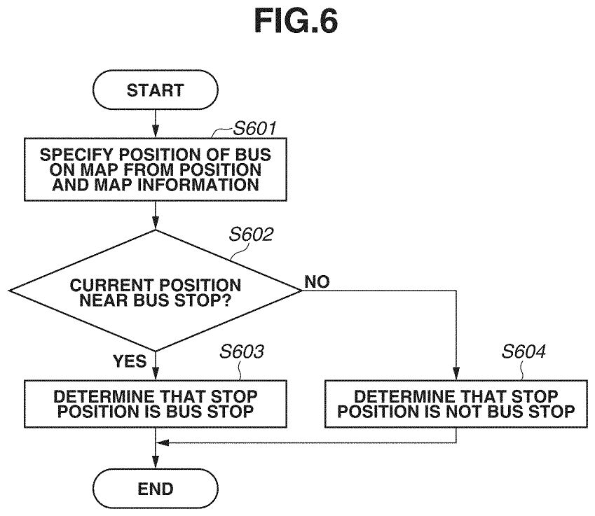

A subroutine of the stop position confirmation processing is described with reference to a flowchart in FIG. 6.

In step S601, the system control unit 203 specifies a position of the bus on the map using the position information indicating the current position of the bus obtained from the sensor input unit 207 and the map information obtained from the map information database 400.

In step S602, the system control unit 203 determines whether the stop position of the bus obtained in step S601 is near a bus stop (a predetermined position) For example, in a case where the current position of the bus is in a predetermined range (for example, within 10 m) from the bus stop specified based on the map information, the system control unit 203 determines that the bus is stopped near the bus stop. In a case where it is determined that the stop position of the bus is near the bus stop (YES in step S602), the processing proceeds to step S603. In step S603, the system control unit 203 determines that the current stop position of the bus is the bus stop. In a case where it is determined that the stop position of the bus is not near the bus stop (NO in step S602), the processing proceeds to step S604. In step S604, the system control unit 203 determines that the current stop position of the bus is not the bus stop.

In step S602, the system control unit 203 may specify the stop position of the bus from a sound obtained through the audio input unit 106. For example, a method may be used which determines whether the current position of the bus is the bus stop by collating the current audio signal with a trained model that has learned sounds occurring when the bus stops at the bus stop, such as opening and closing sounds of the door and an announcement sound.

Alternatively, in step S602, the system control unit 203 may specify the stop position of the bus using a method for performing image recognition processing and collating a result of the processing with an image that is seen while the bus stops. For example, a method may be used. which determines whether the current position of the bus is the bus stop by collating a captured image of the current surroundings of the bus with a trained model that has learned images generated when the bus stops at the bus stop such as an image of the bus stop.

The subroutine of the stop position confirmation may be omitted. In other words, display control to be described below may be performed depending on whether the bus is stopped regardless of the stop position of the bus.

Returning to the description of step S504 in FIG. 5A, the system control unit 203 determines whether the stop position of the bus is the bus stop according to a result of the determination described with reference to FIG. 6. In a case where the stop position of the bus is the bus stop (YES in step S504), the processing proceeds to step S505, whereas in a case where the stop position of the bus is not the bus stop (NO in step S504), the processing proceeds to step S506.

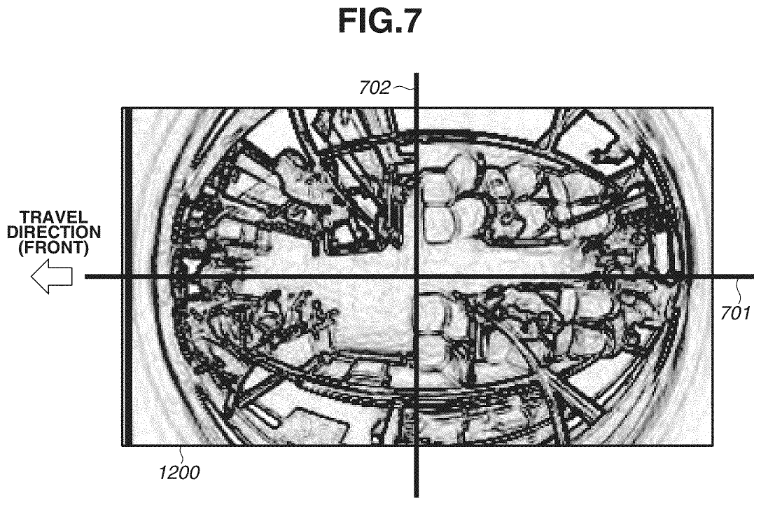

In step S505, the system control unit 203 transmits a command to the image capturing apparatus 100 via the communication unit 204 and causes the image capturing apparatus 100 to generate panoramic ages generated by dividing the fisheye image by a line segment 701 in a direction along the travel direction of the bus. As illustrated in FIG. 7, the fisheye image 1200 is divided by the line segment 701 into an image having an angle of view for capturing the side (a right side) of the bus and an image having an angle of view for capturing an opposite side (a left side) of the bus from the inside of the bus. In the following description, these images are appropriately referred to as a side direction image (right) and a side direction image (left).

On the other hand, in step S506, the system control unit 203 transmits a command to the image capturing apparatus 100 via the communication unit 204 and causes the image capturing apparatus 100 to generate panoramic images by dividing the fisheye image by a line segment perpendicular to the travel direction of the bus. As illustrated in FIG. 7, the fisheye image 1200 is divided by a line segment 702 into an image having an angle of view for capturing the rear of the bus and an image having an angle of view for capturing the front of the bus from the inside of the bus. In the following description, these images are appropriately referred to as a rear image and a front image.

In step S507, the system control unit 203 causes the image capturing apparatus 100 to generate panoramic images by dewarping (distortion correction) the divided fisheye images.

In FIG. 5A, the example is described in which the panoramic images are exclusively generated by the method described in step S505 or the method described in step S506. However, the panoramic images may be generated using both of the method described in step S505 and the method described in step S506. In this case, a priority image to be displayed is selected by the client apparatus 200.

In step S508, the system control unit 203 acquires the panoramic images generated in step S507 via the communication unit 204. In a case where it is determined that the current position is the bus stop, the system control unit 203 acquires only the image including the doorway of the bus from among the plurality of the panoramic images. This is because the image of the side with the doorway is more important than the other side direction image.

Further, in a case where it is determined that the current position is not the bus stop, only the image having the angle of view for capturing the rear of the bus from inside of the bus may be generated. This is because the image having the angle of view for capturing the rear is more important than the front image.

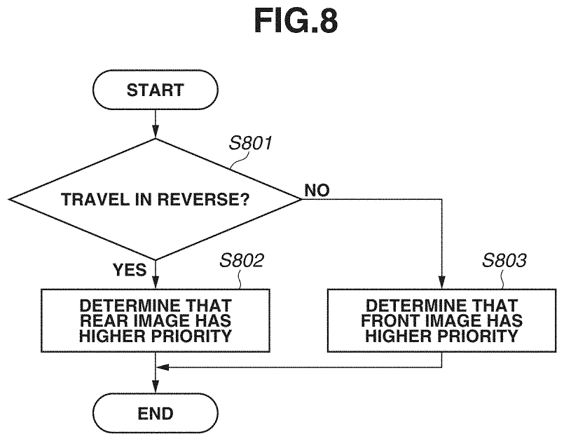

Further, in step S506, in a case where the panoramic images are generated by dividing the fisheye image by the line segment perpendicular to the travel direction of the bus, the processing may be performed as follows. Specifically, either of the rear image and the front image is selected on a priority basis and acquired from the image capturing apparatus 100, A method for determining the priority is described with reference to FIG. 8.

In step S801, the system control unit 203 determines whether the bus is traveling in reverse. In a case where the bus is traveling in reverse (YES in step S801), the processing proceeds to step S802. In a case where the bus is not traveling in reverse (NO in step S801), the processing proceeds to step S803.

In step S802, the system control unit 203 determines that the rear image of the dewarped panoramic images has a higher priority.

In step S803, the system control unit 203 determines that the front image of the dewarped panoramic images has a higher priority.

In image priority information confirmation processing in FIG. 8, a method for determining the priority by performing image recognition on the panoramic images may be used. For example, it may be determined that a panoramic image including the image of the door has a higher priority. Further, in a case where a specific object such as a person is detected in a panoramic image, it may be determined that the panoramic image has a higher priority, In a case where presence or absence of the door is determined, the method can be applied to the panoramic images (side direction images) generated by the processing in step S506. In other words, a higher priority may be set to the image including the image of the door.

In a case where the processing in FIG. 8 is performed, the image that is determined to have a higher priority is preferentially displayed. The captured image that is determined to have a lower priority may not be acquired from the image capturing apparatus 100.

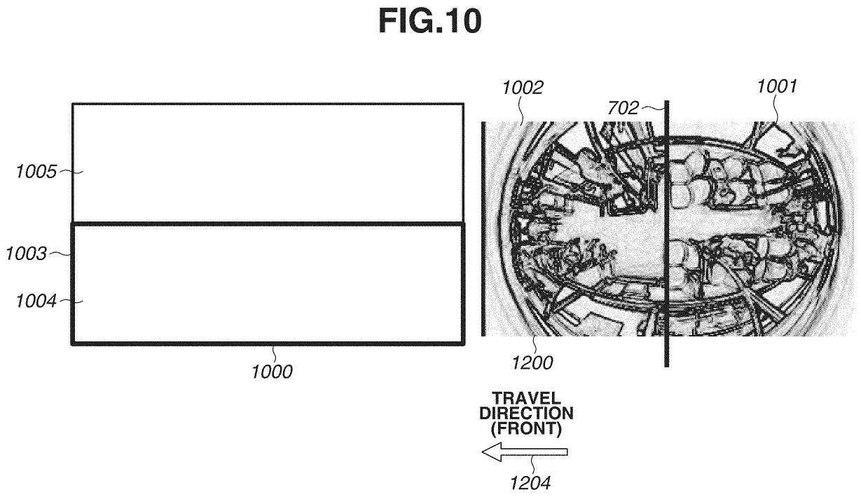

In a case where the processing in FIG. 8 is performed, a display as illustrated in FIG. 10 may be performed. FIG. 10 illustrates an example of a double panorama image in which the front image and the rear image are displayed.

FIG. 10 illustrates a display frame 1000 of the double panorama image including panoramic images obtained by dividing a fisheye image into two parts and expanding the two parts. The fisheye image 1200 is divided by the line segment 702 thereon in panoramic expansion, and images 1001 and 1002 of the fisheye image are expanded into panoramic images. The panoramic image generated by dewarping a rear image 1001 in which the rear in the bus is captured is displayed in a display area 1005. The panoramic image generated by dewarping a front image 1002 in which the front in the bus is captured is displayed in a display area 1004. In a case where it is determined that the front image has a higher priority by the processing in FIG. 8, the display area 1004 for the panoramic image having the higher priority is displayed to be emphasized with a thick line like a frame 1003. As in this example, a panoramic image having a higher priority is displayed with emphasis. An emphasizing method is not limited to a method for emphasizing an image with a frame, and an image with a higher priority may be emphasized by changing arrangement of the GUI or the size of a panoramic image display frame for emphasizing a high-priority image.

Next, a flowchart in FIG. 5B is described. The flowchart is an example of using a plurality of image capturing apparatuses 100 not using a fisheye lens. FIG. 5B is different from FIG. 5A only in steps S510 and S511, and the other steps are the same. In this example, it is assumed that four image capturing apparatuses 100 are installed in the bus as an example. More specifically, the four image capturing apparatuses 100 respectively capture the side direction image (right), the side direction image (left), the rear image, and the front image.

Based on a result of the determination described with reference to FIG. 6, in a case where the stop position of the bus is the bus stop (YES in step S504), the processing proceeds to step S510, whereas in a case where the stop position of the bus is not the bus stop (NC) in step S504), the processing proceeds to step S511.

In step S510, the system control unit 203 causes the image capturing apparatus 100 that captures an image in the side direction (the right direction) of the bus from the inside of the bus to generate a captured image via the communication unit 204. The system control unit 203 further causes the image capturing apparatus 100 that captures an image in the side direction (the left direction) of the bus from the inside of the bus to generate a captured image. At this time, the system control unit 203 may cause only the image capturing apparatus 100 that captures an image of the side with the door to execute image capturing.

On the other hand, in step S511, the system control unit 203 causes the image capturing apparatus 100 that captures an image of the rear of the bus from the inside of the bus to generate a captured image via the communication unit 204. The system control unit 203 further causes the image capturing apparatus 100 that captures an image of the front of the bus from the inside of the bus to generate a captured image. At this time, the system control unit 203 may cause only the image capturing apparatus 100 that captures an image of the rear to execute image capturing.

Then, in step S508, the system control unit 203 of the client apparatus 200 acquires the captured image captured in step S510 or S511. The system control unit 203 may acquire all of the side direction image (right), the side direction image (left), the rear image, and the front image in step S508. In this case, the system control unit 203 of the client apparatus 200 selects an image to be displayed based on the priority of each image as described below.

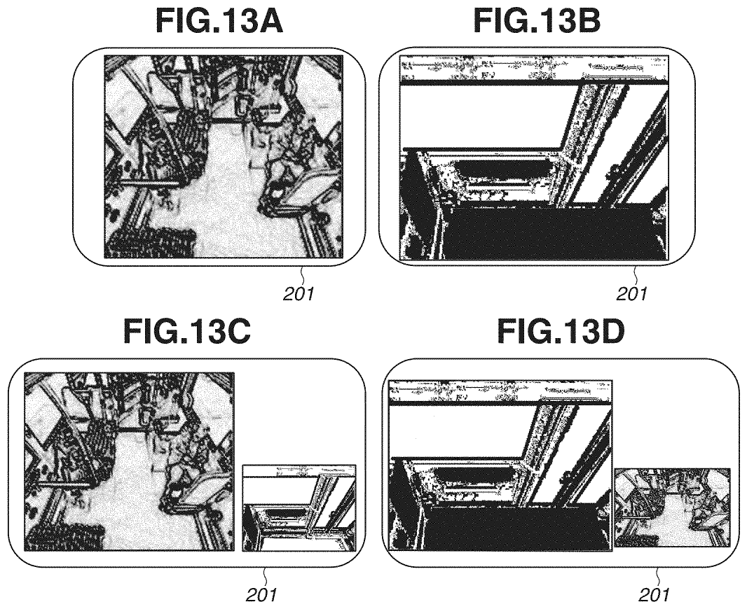

Next, an image display control method according to the present exemplary embodiment is described with reference to FIGS. 13A to 13D.

FIG. 13A illustrates a display example in a case where it is determined that the bus is not stopped at the bus stop in step S504. In a case where it is determined that the bus is not stopped at the bus stop, the system control unit 203 acquires at least the rear image and displays the image on the display unit 201 as illustrated in FIG. 13A. The front image may also be displayed at this time, Furthermore, in a case where the bus is not stopped, the display as illustrated in FIG. 13A may be presented regardless of the stop position of the bus.

FIG. 13B illustrates a display example in a case where it is determined that the bus is stopped at the bus stop in step S504. In a case where it is determined that the bus is stopped at the bus stop, the system control unit 203 acquires at least the side direction image including the door and displays the image on the display unit 201 as illustrated in FIG. 13B. Both of the side direction images may be displayed at this time. Furthermore, in a case where the bus is stopped, the display as illustrated in FIG. 13B may be presented regardless of the stop position of the bus. As described above, the side direction image and the rear image/the front image are selectively displayed in the examples of FIGS. 13A and 13B.

FIG. 13C illustrates another display example in a case where it is determined that the bus is not stopped at the bus stop in step S504. As illustrated in FIG. 13C, the system control unit 203 displays the rear image larger than the side direction image (the other image) in size. In a case where the bus is not stopped, the display as illustrated in FIG. 13C may be presented regardless of the stop position of the bus.

FIG. 13D illustrates another display example in a case where it is determined that the bus is stopped at the bus stop in step S504. As illustrated in FIG. 13D, the system control unit 203 displays the side direction image larger than the rear image (the other image) in size. In a case where the bus is stopped, the display as illustrated in FIG. 13D may be presented regardless of the stop position of the bus.

As described above, the system control unit 203 determines the priority of each image according to a result of the determination regarding whether the bus is stopped, and controls the display of each image according to the priority. Furthermore, the system control unit 203 determines the priority of each image according to a result of the determination regarding whether the bus is stopped at the bus stop, and controls the display of each image according to the priority. In a case where the client apparatus 200 receives all the captured images, the system control unit 203 determines which image(s) is to be displayed and how the image(s) is displayed.

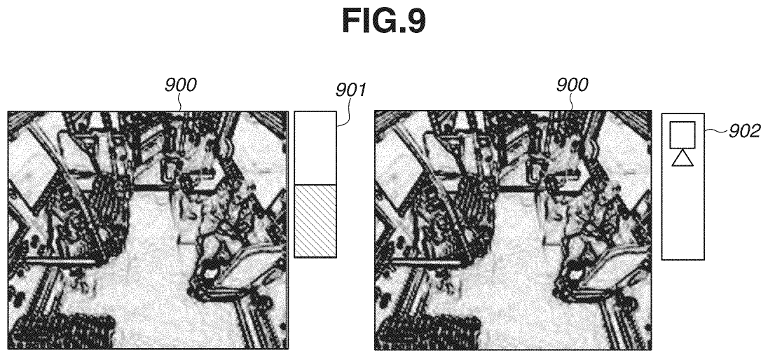

Next, a method for making it easy to understand which area of the bus is presented. in the image displayed. on the display unit 201 is described with reference to FIG. 9.

The description of the method is given with a rear image 900 as an example, An icon 901 indicates that the image is the rear image. A portion corresponding to the rear of the bus is indicated by hatching. Similarly, in an icon 902, an icon representing a camera faces the portion corresponding to the rear of the bus.

The icon is changed depending on whether the image to be displayed is the side direction image (right), the side direction image (left), the rear image, or the front image. The icon may be superimposed on the captured image. Further, which position in the bus is presented in the displayed captured image may be indicated by displaying information indicating a display position on the GUI on a display screen without being limited to the icon.

As described above, according to the present exemplary embodiment, a display control is performed according to whether a movable body is traveling or not, so that an image captured by an image capturing apparatus installed in the movable body can be appropriately displayed.

According to a second exemplary embodiment, an example is described in which a display control is performed according to not only whether a movable body is traveling but also whether an abnormality is detected. Descriptions of parts similar to those according to the first exemplary embodiment are omitted as appropriate.

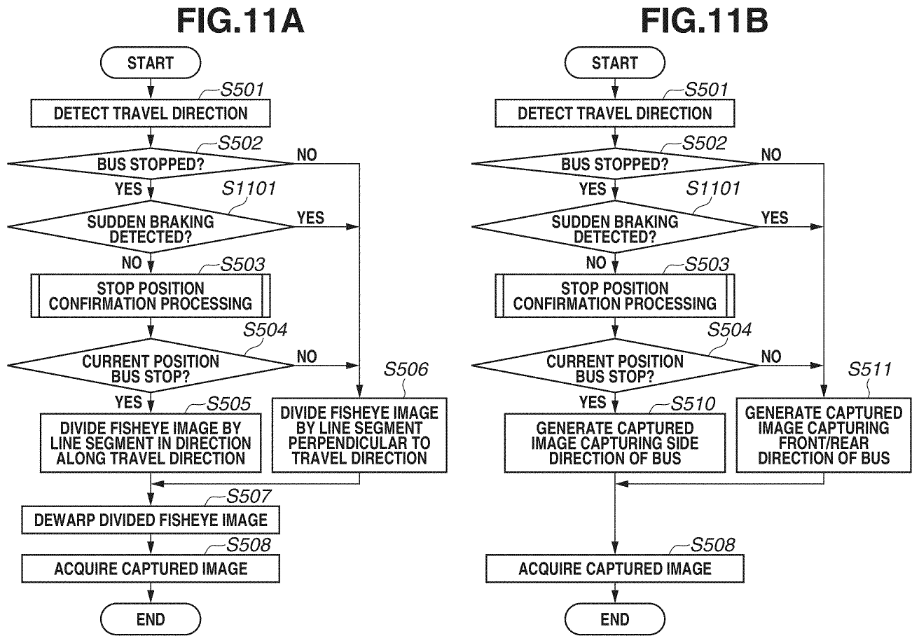

Flowcharts according to the second exemplary embodiment are described with reference to FIGS. 11A and 11B. Only step S1101 is different from the flowcharts according to the first exemplary embodiment.

In step S1101, the system control unit 203 determines whether sudden braking is applied based on an output from an acceleration sensor and the like in response to an input from the sensor input unit 207.

In FIG. 11A, in a case where sudden braking is applied (YES in step S1101), the processing proceeds to step S506. Then, the rear image and the front image are displayed with priority over the side direction images. On the other hand, in a case where sudden braking is not applied (NO in step S1101), the processing proceeds to step S503.

In FIG. 11B, in a case where sudden braking is applied (YES in step S1101), the processing proceeds to step S511. Then, the rear image and the front image are displayed with priority over the side direction images. On the other hand, in a case where sudden braking is not applied (NO in step S1101), the processing proceeds to step S503.

As described above, in a case where sudden braking is applied, the rear image and the front image can be displayed with priority over the side direction images. Particularly, it is desirable to display the rear image with a higher priority. cl Other Exemplary Embodiments

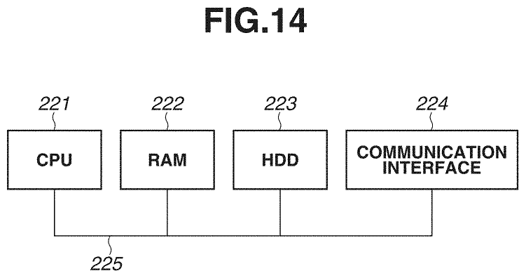

A hardware configuration for realizing the client apparatus 200 and the image capturing apparatus 100 according to each exemplary embodiment is described with reference to FIG. 14.

A random access memory (RAM) 222 temporarily stores a computer program to be executed by a central processing unit (CPU) 221. The RAM 222 also temporarily stores data (a command and image data) and the like acquired from an external device via a communication interface 224. Furthermore, the RAM 222 provides a work area to be used by the CPU 221 to execute various processing. The RAM 222 also functions as, for example, a frame memory and a buffer memory.

The CPU 221 executes the computer program stored in the RAM 222. Other than the CPU 221, a processor such as a digital signal processor (DSP) and an application specific integrated circuit (ASIC) may be used.

A hard disk drive (HDD) 223 stores a program of an operating system and image data. The HDD 223 also stores a computer program.

The computer program and data stored in the HDD 223 are loaded into the RAM 222 according to control by the CPU 221 and executed by the CPU 221 as appropriate. Other than the HDD 223, another storage medium such as a flash memory may be also used. A bus 225 connects the hardware components to each other. The hardware components exchange data with each other via the bus 225. The hardware configuration according to each exemplary embodiment has been described above.

The present disclosure can also be realized by processing which is executed by one or more processors reading out a program for realizing one or more functions of the above-described exemplary embodiments. The program may be supplied to a system or an apparatus including the one or more processors via a network or a storage medium.

The present disclosure can also be realized by a circuit (for example, an ASIC) for realizing the one or more functions of the above-described exemplary embodiments.

Each functional block illustrated in FIG. 2 may be realized by the hardware components illustrated in FIG. 14 or by software.

It is to be understood that the present disclosure is not limited to the above-described exemplary embodiments and can be modified in various ways without departing from the scope of the present disclosure. For example, combinations of each exemplary embodiment are deemed to be within the scope of the present disclosure.

### Other Embodiments

Embodiment(s) of the present disclosure can also be realized by a computer of a system or apparatus that reads out and executes computer executable instructions (e,g., one or more programs) recorded on a storage medium (which may also be referred to more fully as a ‘non-transitory computer-readable storage medium’) to perform the functions of one or more of the above-described embodiment(s) and/or that includes one or more circuits application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)198 ), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2020-181728, filed Oct. 29, 2020, which is hereby incorporated by reference herein in its entirety.

What is claimed is:

1. A display control apparatus which controls a display of a plurality of captured images captured by one or a plurality of image capturing apparatuses installed inside of a movable body, the display control apparatus comprising:
a determination unit configured to determine whether movement of the movable body is stopped; and
a display control unit configured to control the display of the plurality of captured images on a display unit so that a first captured image having an angle of view for capturing a side of the movable body from the inside of the movable body and a second captured image different from the first captured image are selectively displayed among the plurality of captured images based on at least a result of the determination by the determination unit.

2. The display control apparatus according to claim 1, wherein, in a case where the determination unit determines that the movement of the movable body is stopped, the display control unit controls the display of the plurality of captured images to change from a state in which the second captured image is displayed to a state in which the first captured image is displayed.

3. The display control apparatus according to claim 1, wherein the determination unit determines whether the movement of the movable body is stopped at a predetermined position.

4. The display control apparatus according to claim 3,
wherein the movable body is a bus, and
wherein the predetermined position is a bus stop.

5. The display control apparatus according to claim 1,
wherein the movable body is a bus, and
wherein the first captured image is an image having an angle of view for capturing a side where there is a door among a plurality of sides of the bus.

6. The display control apparatus according to claim 1, wherein the second captured image is an image having an angle of view for capturing a rear or a front of the movable body from the inside of the movable body,

7. The display control apparatus according to claim 1,
wherein the one or plurality of image capturing apparatuses is each an image capturing apparatus using a fisheye lens, and
wherein the first captured image is an image generated by dividing a fisheye image captured using the fisheye lens by a line segment extending in a direction along a travel direction of a bus and performing distortion correction processing on divided images.

8. The display control apparatus according to claim 1,
wherein the one or plurality of image capturing apparatuses is each an image capturing apparatus using a fisheye lens, and
wherein the second captured image is an image generated by dividing a fisheye image captured using the fisheye lens by a line segment extending in a direction perpendicular to a travel direction of a bus and performing distortion correction processing on divided images.

9. A display control apparatus which controls a display of a plurality of captured images captured by one or a plurality of image capturing apparatuses installed inside of a movable body, the display control apparatus comprising:
a determination unit configured to determine whether movement of the movable body is stopped; and
a display control unit configured to control the display of the plurality of captured images on a display unit so that one of a first captured image having an angle of view for capturing a side of the movable body from the inside of the movable body and a second captured image different from the first captured image is displayed in a larger size than the other among the plurality of captured images based on at least a result of the determination by the determination unit.

10. The display control apparatus according to claim 9, wherein, in a case where the determination unit determines that the movement of the movable body is stopped, the display control unit controls the display of the plurality of captured images to change from a state in which the second captured image is displayed in a larger size than the first captured image to a state in which the first captured image is displayed in a larger size than the second captured image.

11. The display control apparatus according to claim 9,
wherein the movable body is a bus, and
wherein the first captured image is an image having an angle of view for capturing a side where there is a door among a plurality of sides of the bus.

12. The display control apparatus according to claim 9, wherein the second captured image is an image having an angle of view for capturing a rear or a front of the movable body from the inside of the movable body.

13. The display control apparatus according to claim 9,
wherein the one or plurality of image capturing apparatuses is each an image capturing apparatus using a fisheye lens, and
wherein the first captured image is an image generated by dividing a fisheye image captured using the fisheye lens by a line segment extending in a direction along a travel direction of a bus and performing distortion correction processing on divided images.

14. The display control apparatus according to claim 9,
wherein the one or plurality of image capturing apparatuses is each an image capturing apparatus using a fisheye lens, and
wherein the second captured image is an image generated by dividing a fisheye image captured using the fisheye lens by a line segment extending in a direction perpendicular to a travel direction of a bus and performing distortion correction processing on divided images.

15. A method for controlling a display of a plurality of captured images captured by one or a plurality of image capturing apparatuses installed inside of a movable body, the method comprising:
determining whether movement of the movable body is stopped; and
controlling the display of the plurality of captured images on a display unit so that a first captured image having an angle of view for capturing a side of the movable body from the inside of the movable body and a second captured image different from the first captured image are selectively displayed among the plurality of captured images based on at least a result of the determining.

16. A method for controlling a display of a plurality of captured images captured by one or a plurality of image capturing apparatuses installed inside of a movable body, the method comprising:
determining whether movement of the movable body is stopped; and
controlling the display of the plurality of captured images on a display unit so that one of a first captured image having an angle of view for capturing a side of the movable body from the inside of the movable body and a second captured image different from the first captured image is displayed in a larger size than the other among the plurality of captured images based on at least a result of the determining.

17. A non-transitory computer readable storage medium storing a program for causing a computer to execute a method for controlling a display of a plurality of captured images captured by one or a plurality of image capturing apparatuses installed inside of a movable body, the method comprising:
determining whether movement of the movable body is stopped; and
controlling the display of the plurality of captured images on a display unit so that a first captured image having an angle of view for capturing a side of the movable body from the inside of the movable body and a second captured image different from the first captured image are selectively displayed among the plurality of captured images based on at least a result of the determining.

18. A non-transitory computer readable storage medium storing a program for causing a computer to execute a method for controlling a display of a plurality of captured images captured by one or a plurality of image capturing apparatuses installed inside of a movable body, the method comprising:
determining whether movement of the movable body is stopped; and
controlling the display of the plurality of captured images on a display unit so that one of a first captured image having an angle of view for capturing a side of the movable body from the inside of the movable body and a second captured image different from the first captured image is displayed in a larger size than the other among the plurality of captured images based on at least a result of the determining.
